(19) United States
(12) Patent Application Publication
(10) Pub. No.: US 2025/0210774 A1
(43) Pub. Date: Jun. 26, 2025

(54) BATTERY SUPPORT ARRANGEMENT WITH RAMP SHEET METAL

(71) Applicant: BENTELER AUTOMOBILTECHNIK GMBH, Paderborn (DE)

(72) Inventors: Peter Michael STASTNY, Delbrueck (DE); Andreas HITZ, Erwitte (DE)

(21) Appl. No.: 18/977,931

(22) Filed: Dec. 12, 2024

(30) Foreign Application Priority Data
Dec. 21, 2023 (EP) 23219240.1

(51) Int. Cl. H01M 50/242; B60K 1/04; H01M 50/224; H01M 50/236; H01M 50/249

(52) U.S. Cl. CPC H01M 50/242; B60K 1/04; H01M 50/224; H01M 50/236; H01M 50/249; B60K 2001/0438

(57) ABSTRACT

The present invention relates to a battery support arrangement of an electric motor vehicle, having a battery support which is arranged in the underfloor region of the electric motor vehicle, and a front axle support, and a single-shell ramp sheet metal extending in the motor vehicle longitudinal direction is arranged in the transition from the front axle support to the battery support, as a hot molded and press hardened component with a tensile strength Rm greater than 1200 MPa.

The present invention relates to a battery support arrangement of an electric motor vehicle according to the features in the preamble of claim 1.

For many decades passenger cars have been known from the prior art which, by means of an internal combustion engine drive, make it possible to transport persons and light loads from one place to the next.

In recent years, the drive has gradually changed from an internal combustion engine drive to an electric drive. An electric drive requires an energy storage source, also called a drive battery. However, in order for a passenger car of up to 7.5 tons including payload to carry a corresponding energy supply, such drive batteries must have a large surface area and weigh up to several 100 kilograms.

For this purpose, the batteries or storage cells are usually accommodated in a so-called battery support, also referred to as battery tray. It is possible to arrange such a battery support in the underfloor region, i.e. underneath the passenger compartment. Thus, the electric motor vehicle has a low center of gravity, which has a positive effect on the driving behavior, especially in cornering.

In the event of a vehicle crash, the battery support must be protected as far as possible so that the storage cells accommodated therein do not suffer any mechanical damage. On the one hand, there is a risk of fire development in the event of accidents; on the other hand, the replacement of the storage cells involves considerable financial effort.

DE 10 2022 126585 B3 discloses a front protective cap which is arranged between a battery support and a front axle above a separating plane.

Furthermore, US Pat. No. 2022/379963 A1 discloses a battery support arrangement which is supported on a front axle via support struts.

The object of the present invention is therefore to show a solution, whereby in certain driving situations, in particular in the event of a vehicle crash, damage to a battery support is avoided as far as possible.

The above-mentioned object is achieved according to the invention with a battery support arrangement of an electric motor vehicle having the features of claim 1.

Advantageous embodiment variants are described in the dependent claims.

The battery support arrangement is provided for an electric motor vehicle. For this purpose, the electric motor vehicle has a battery support which is arranged in the underfloor region of the electric motor vehicle. The battery support is a battery box which extends in particular in the transverse direction of the motor vehicle over more than 50%, in particular more than 60%, preferably more than 70%, of the width of the motor vehicle. The battery support preferably has a front running essentially in the transverse direction of the motor vehicle. The battery support is arranged in the underfloor region of the electric motor vehicle.

Furthermore, the battery support arrangement has a front axle support, which can also be referred to as a motor axle support. The front axle support is designed in particular as a frame component and accommodates components of the front axle in order thus to fasten or arrange the front axle below the body of the electric motor vehicle.

According to the invention, the battery support arrangement is characterized in that a single-shell ramp sheet metal extending or running in the motor vehicle longitudinal direction is arranged in a transition region from the front axle support to the battery support. According to the invention, the ramp sheet metal is also designed as a hot molded and press hardened component with a tensile strength Rm of greater than 1200 MPa.

The ramp sheet metal according to the invention performs two functions. In the event of a frontal crash, it reinforces the region, in particular it is coupled to the front axle support and the battery support. It thus prevents intrusion of the front axle support into the battery support. The ramp sheet metal fulfills a second purpose, in that, in the case of impact on a ground obstacle or when passing over a ground obstacle, the ramp sheet metal prevents the ground obstacle from penetrating frontally into the battery support and damaging the battery support. The ramp sheet metal makes it possible for the ground obstacle to slide or deviate beneath the battery support, so that further damage is avoided.

The ramp sheet metal is coupled, in particular screwed, to the front axle support and/or to the battery support. This permits a simple mounting of the ramp sheet metal. Because hot-molding and press-hardening technology is used and a component made of high-strength, in particular ultra-high-strength steel is thus provided, the ramp sheet metal can be designed as a single-shell sheet metal component. In particular, this saves weight and production costs in comparison with other components which would be produced with significantly more material expenditure and/or significantly more material use and/or increased production costs.

The ramp sheet metal itself is preferably produced from a one-piece sheet metal blank of uniform material. Alternatively, the ramp sheet metal can be produced from a tailor welded blank, i.e. a sheet metal blank which is welded together from a plurality of different sheet metals having different sheet thicknesses and/or sheet metal material qualities.

The ramp sheet metal has a ramp surface which runs obliquely with respect to the motor vehicle longitudinal direction and which preferably extends over a large part of the width of the battery support. In particular, the ramp surface covers the entire front region of the battery support extending in the transverse direction of the motor vehicle.

The ramp surface is preferably arranged at an angle of 3° to 20° to a horizontal direction or to the motor vehicle longitudinal direction. In this way, ground obstacles can then be diverted downwards and below the battery support by the ramp surface.

Furthermore, coupling regions are particularly preferably formed. In particular, this relates to recesses in the ramp sheet metal. These can particularly preferably have a lower strength than the remaining ramp sheet metal. This increases ductility. In the event of an accident, these regions cannot be torn off. However, the remaining regions with high tensile strength of the ramp sheet metal ensure a corresponding stiffening in the event of an accident.

A front coupling surface and/or a rear coupling surface are arranged so as to extend substantially parallel to the motor vehicle longitudinal direction or to a plane defined by the motor vehicle longitudinal direction and the transverse direction of the motor vehicle. This makes it possible to then fasten the ramp sheet metal underneath the front axle support and underneath the battery support. The ramp surface extending therebetween then slopes downwards at an angle. The front surface underneath the front axle support and/or the rear surface underneath the battery support are each designed as a rectangle in plan view. The extension in the motor vehicle longitudinal direction is clearly shorter than the extension in the transverse direction of the motor vehicle. The extension in the transverse direction of the motor vehicle preferably corresponds to the width of the battery support. This in turn corresponds to a large part of the width of the motor vehicle itself.

Furthermore, reinforcement beads can be formed in the motor vehicle longitudinal direction, at least in longitudinal portions. Within the reinforcement beads 11, or preferably in flat sheet metal regions between the beads, coupling surfaces for the front axle support attachment and/or previously mentioned spacers can again be provided. These are then formed in particular in the ramp region or the ramp surface of the ramp sheet metal. The ramp surface is thus reinforced once more and makes it possible for ground obstacles to slide downwards below the motor vehicle.

Alternatively or additionally, reinforcement patches can be arranged on the ramp sheet metal. These are then arranged on the side facing away from the substrate, i.e. on an inner side of the ramp sheet metal, and are preferably hot-molded and press-hardened together to form the ramp sheet metal.

It has furthermore proved to be particularly advantageous if the ramp sheet metal extends at least up to half under the front axle support in the motor vehicle longitudinal direction.

For further stiffening, further spacers can be arranged between an inner side of the ramp sheet metal and the front axle support under the battery support. This, too, provides for additional stiffening of the ramp sheet metal.

A further aspect of the invention provides for a buffer element to be arranged in the ramp sheet metal in front of the battery support in the motor vehicle longitudinal direction. The buffer element functions according to the principle of a crashbox or a stop. In the event of an underfloor frontal crash, i.e. a frontal crash which would affect a front side of the battery support in the motor vehicle longitudinal direction, energy is dissipated in accordance with the operating principle of a crashbox. For this purpose, for example, a hollow profile can be additionally arranged in front of the battery support on the inside of the ramp sheet metal. The hollow profile can simultaneously serve as a spacer and stiffening element. However, if the crash energy is so great that the ramp sheet metal itself is deformed, the hollow profile serves as a crash box and protects a front side of the battery support.

The buffer element can also be designed as a stop. This thus reinforces the screwing of the ramp sheet metal to the battery support in the event of a frontal impact or frontal crash. The force which acts in the motor vehicle longitudinal direction would otherwise lead to high loads, possibly to a tearing off of the ramp sheet metal. The buffer element thus provides a stop in such a way that the ramp element is not pressed underneath the battery support.

A battery support arrangement according to the invention interacts synergistically, particularly in conjunction with a battery support which is sufficiently protected against breakdown and with an integrated or mounted underride guard, wherein it is possible for the obstacle to slide further after the ramp sheet metal under the battery support or its underride guard.

Further advantages, features, properties, and aspects of the present invention are the subject matter of the following description. Preferred embodiment variants are shown in the schematic figures. These simplify the understanding of the invention. In the figures:

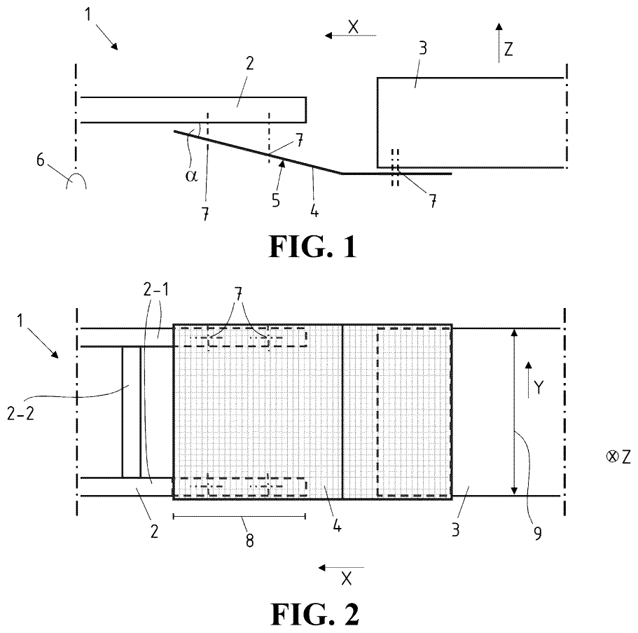

FIG. 1 schematically shows a battery support arrangement according to the invention in a simplified manner;

FIG. 2 shows a view from below of the battery support arrangement according to the invention;

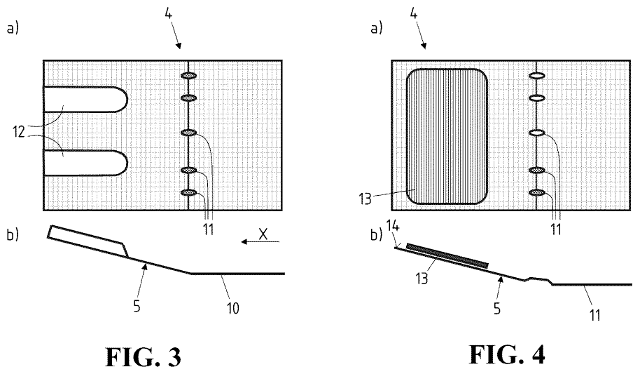

FIGS. 3a and b show a side view and a view from below on a modified ramp sheet metal;

FIGS. 4a and b show an alternative design variant of the ramp sheet metal;

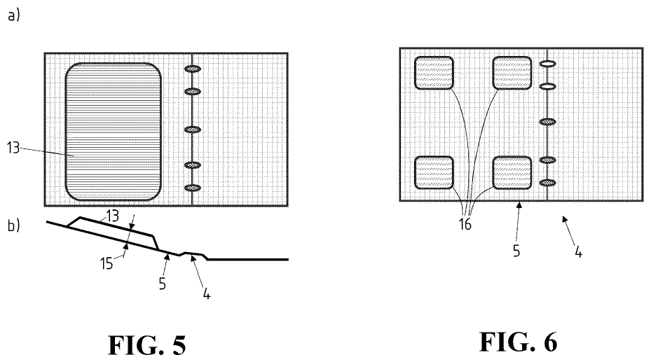

FIGS. 5a and b show an alternative with a reinforcement patch;

FIG. 6 shows an alternative design variant;

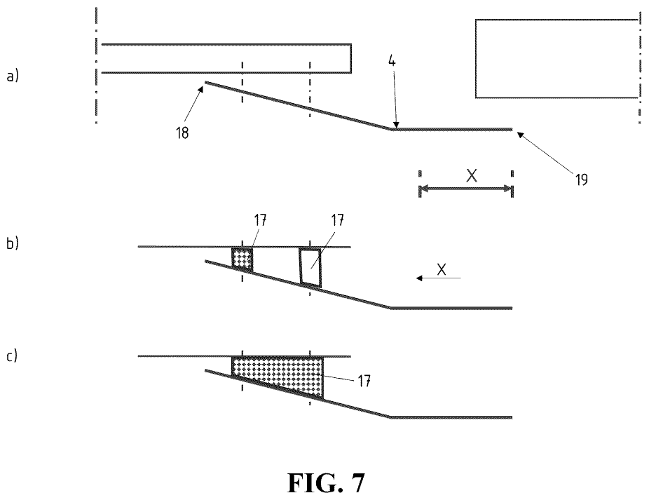

FIGS. 7a, b and c show an alternative design variant according to FIG. 1;

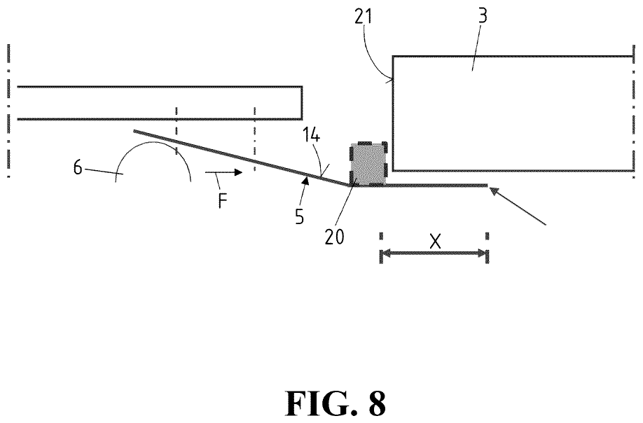

FIG. 8 shows a further design variant with a buffer element;

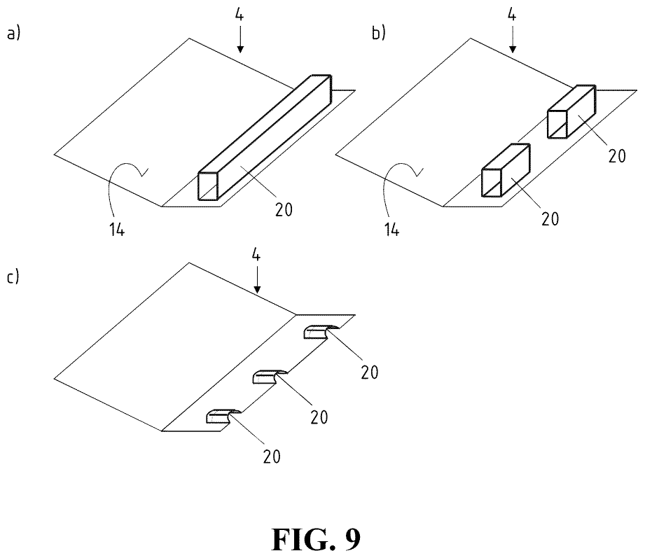

FIGS. 9a, b and c show different buffer elements and

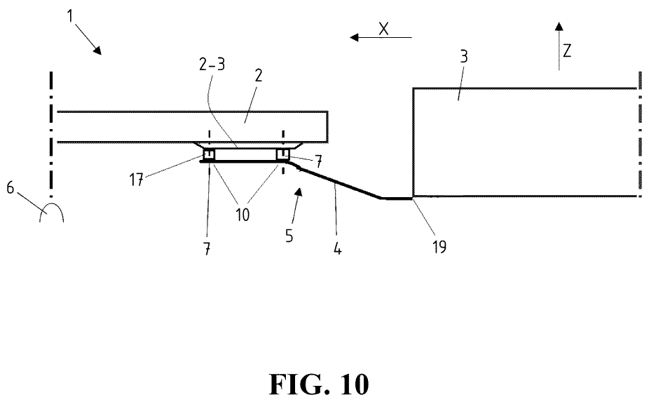

FIG. 10 shows an alternative arrangement to FIG. 1.

In the figures, the same reference numerals are used for same or similar components, even if a repeated description is omitted for reasons of simplicity.

FIG. 1 shows a schematically simplified side view of a battery support arrangement 1 according to the invention. A front axle support 2 is shown, comprising transverse supports 2-2 and two longitudinal supports 2-1 as well as a battery support 3 arranged behind the longitudinal direction X of the motor vehicle. With respect to the vertical direction Z of the motor vehicle, a ramp sheet metal 4 is arranged according to the invention below the battery support 3 and below the front axle support, and the ramp sheet metal 4 has an inclined ramp surface 5 for this purpose. The ramp surface 5 lies at an angle α to the longitudinal direction X of the motor vehicle. A bollard or object coming from the front, which is not shown in detail, is thus deflected by the inclined ramp surface 5 below the battery support 3, or the vehicle is raised correspondingly upwards by the ramp surface. Damage to the battery support 3 is thus effectively avoided. Screw connections may be provided, for example, on the front axle support, but also on the battery support 3, in any case at least over a width occupied by the battery cells or battery packs

Likewise, the coupling surfaces provided for the preferably frictional and releasable fastening of the ramp sheet metal to the front axle support are shown, which in this case, by way of example, are provided on the longitudinal supports of the front axle support running in the longitudinal direction of the vehicle.

FIG. 2 shows a view from below of the battery support arrangement 1 according to the invention. In the longitudinal direction X of the motor vehicle, the ramp sheet metal 4 extends at least over half of the front axle support 2. Referring to the transverse direction Y of the motor vehicle, the ramp sheet metal 4 preferably extends over the entire width of the battery support 3.

FIGS. 3a and b show a side view and a view from below onto a modified ramp sheet metal 4. The ramp sheet metal 4 has a front ramp surface 5 and a rear coupling surface 10. The coupling surface 10 lies at least partially below a battery support 3, not shown in detail, and runs essentially parallel to a horizontal or longitudinal direction X of the motor vehicle. Individual reinforcement beads 11 are arranged at the transition from the coupling region to the ramp surface 5. In addition, larger reinforcement beads 11 are arranged in the front region and extend over the ramp surface 5 at least in portions in the longitudinal direction X of the motor vehicle.

FIGS. 4a and b show an alternative embodiment variant of the ramp sheet metal 4. In this case, a reinforcement patch 13 is arranged on an inner side 14 of the ramp sheet metal 4, in particular in the ramp surface 5. Furthermore, reinforcement beads 11 are again in the transition region between ramp surface 5 and coupling surface 10.

FIGS. 5a and b also show an arranged reinforcement patch 13. However, this reinforcement patch 13 is arranged at a distance 15 from the ramp surface 5 of the ramp sheet metal 4, thereby forming one or multiple stiffening cavities. The reinforcement patch 13 can thus also function according to the principle of a crashbox, so that a reinforcement 7 is provided for the purpose of deflecting an object. If, however, the impact is of such high intensity that intrusion is likely to occur, the reinforcement pad 13 would reinforce the ramp sheet metal 4.

FIG. 6 shows an alternative design variant. In this case, four so-called soft zones 16 are arranged in the ramp region. The soft zones are regions with lower tensile strength Rm and are used for energy dissipation and/or crack prevention in coupling surfaces.

FIGS. 7a, b and c show an embodiment variant according to FIG. 1. However, according to FIG. 7b and FIG. 7c, a spacer 17 is arranged in each case. According to the spacer 17 in FIG. 7b, two individual spacers 17 are arranged one behind the other in the longitudinal direction X of the motor vehicle. Not shown in detail, but with reference to the transverse direction of the motor vehicle, such an arrangement with spacers is then provided in the region of the left side of the vehicle and in the region of the right side of the vehicle. According to FIG. 7c, a spacer block is provided. Referring again to the left and right sides of the vehicle in the transverse direction Y of the motor vehicle, a respective spacer block can thus be arranged on the left and right sides. Furthermore, with respect to all variants, a front longitudinal edge 18 or a rear longitudinal edge 19 can be formed in each case. The longitudinal edges 18, 19 each preferably extend over the entire width of the ramp sheet metal 4.

Instead of the local arrangement of the spacers, it would also be possible to design them continuously in the transverse direction of the vehicle from a left coupling surface to a right coupling surface, i.e. running between the two front axle longitudinal supports 2-1 according to FIG. 2.

FIG. 8 shows a further design variant. In this case, a buffer element 20 is arranged. The buffer element 20 can be, for example, a hollow profile. Therefore, in case of an object impact, the ramp sheet metal 4 or the ramp surface 5 of the ramp sheet metal 4 is acted upon here in the direction of force f. If the intensity is very high, this object 6 would strike a front side 21 of the battery support 3 and possibly damage it. The buffer element 20 is then arranged here and functions according to the principle of a crash box.

Various buffer elements 20 are shown in FIGS. 9a, b and c. Accordingly, these can be separately constructed hollow profiles which are arranged on an inner side 14 of the ramp sheet metal 4. The buffer elements 20 then deform in the event of an impact of high intensity between the object and the front side 21 of the battery support 3 and thus protect the battery support 3 in the event that the object is not deflected. Furthermore, the buffer elements 20 hold the ramp sheet metal 4 in position in front of the battery support 3.

FIG. 10 shows an alternative embodiment of the invention. It can be seen that a front and a rear coupling surface 10 of the ramp sheet metal 4 extend parallel to the front axle support 2 and to the longitudinal axis of the vehicle.

The ramp sheet metal 4 is connected to the front axle support 2 via indicated sleeves, starting from the coupling surface 10. The front axle support 2 can also have a shaped coupling surface 2-3 which is adapted to the shape and position of the sleeves or reduces a distance from the ramp sheet metal 4.

Furthermore, in this example, the rear longitudinal edge 19 of the ramp sheet metal is flush with the battery support 3 in the vertical direction of the vehicle. In this case, it is flush with respect to the lower part or to the ground or lower vehicle part of the battery support. In the vertical direction of the vehicle, possibly higher regions of the battery support, such as a lateral crash frame, can again be engaged from below by the ramp sheet metal, which is not shown in the very schematic rectangular shape of FIG. 10.

### REFERENCE NUMERALS

1—battery support arrangement
2—front axle support
3—battery support
4—ramp sheet metal
5—ramp surface
6—object
7—screw connection
8—half to 2
9—width to 3
10—coupling surface
11—reinforcement bead
12—larger reinforcement bead
13—reinforcement patch
14—inner side to 4
A—distance
16—soft zone
17—spacer
18—front longitudinal edge
19—rear longitudinal edge
20—buffer element
21—front to 3
X—motor vehicle longitudinal direction
Y—motor vehicle transverse direction
Z—motor vehicle vertical direction
α—angle

1-11: (canceled)

12. A battery support arrangement of an electric motor vehicle, having a battery support which is arranged in the underfloor region of the electric motor vehicle and a front axle support, characterized in that a single-shell ramp sheet metal extending in the motor vehicle longitudinal direction is arranged as a hot-molded and press hardened component with a tensile strength Rm greater than 1200 MPa in the transition from the front axle support to the battery support, and in that the ramp sheet metal has a ramp surface extending obliquely to the motor vehicle longitudinal direction.

13. The battery support arrangement according to claim 12, wherein the ramp sheet metal has a coupling region for connection to the front axle support and/or battery support, wherein the coupling region preferably has a lower strength.

14. The battery support arrangement according to claim 12, wherein the ramp sheet metal has a front longitudinal edge in the motor vehicle longitudinal direction for connection to the front axle support and/or in that the ramp sheet metal has a rear longitudinal edge in the motor vehicle longitudinal direction for connection to the battery support, in particular the ramp sheet metal is coupled at least flush with the battery support in the motor vehicle longitudinal direction, in particular preferably the ramp sheet metal engages under the battery support.

15. The battery support arrangement according to claim 12, wherein the ramp sheet metal is produced from a one-piece and materially uniform sheet metal blank or in that the ramp sheet metal is produced from a tailored blank.

16. The battery support arrangement according to claim 12, wherein the ramp sheet metal has a surface which runs obliquely with respect to the motor vehicle longitudinal direction over a large part of the width of the battery support, preferably at an angle of 3 to 20 degrees.

17. The battery support arrangement according to claim 12, wherein a front coupling surface and/or a rear coupling surface are oriented so as to extend substantially parallel to the motor vehicle longitudinal direction.

18. The battery support arrangement according to claim 12, wherein at least one reinforcement bead running in the motor vehicle longitudinal direction is formed in the ramp sheet metal in longitudinal portions.

19. The battery support arrangement according to claim 12, wherein at least one reinforcement patch is arranged, preferably arranged, in particular coupled, on the side facing away from the ground.

20. The battery support arrangement according claim 12, wherein at least half of the ramp sheet metal extends in the motor vehicle longitudinal direction under the front axle support.

21. The battery support arrangement according to claim 12, wherein spacers are arranged between an inner side of the ramp sheet metal and the front axle support and/or battery support.

22. The battery support arrangement according to claim 12, wherein a buffer element is arranged in the motor vehicle longitudinal direction in front of the battery support on the inner side of the ramp sheet metal.
